(19) United States
(12) Patent Application Publication
(10) Pub. No.: US 2020/0346546 A1
(43) Pub. Date: Nov. 5, 2020

(54) IN-VEHICLE DISPLAY DEVICE

(71) Applicant: LG Electronics Inc., Seoul (KR)

(72) Inventors: Jiwon OH, Seoul (KR); Jinhua PIAO, Seoul (KR); Eunjoung CHO, Seoul (KR)

(21) Appl. No.: 16/957,166

(22) PCT Filed: Dec. 29, 2017
(86) PCT No.: PCT/KR2017/015744

§ 371 Date: Jun. 23, 2020

(30) Foreign Application Priority Data
Dec. 26, 2017 (KR) 10-2017-0179968

(51) Int. Cl. B60K 35/00; G06F 3/01; G06K 9/00

(52) U.S. Cl. CPC B60K 35/00; G06F 3/017; B60K 2370/152; G06K 9/00838; B60K 2370/146; G06K 9/00355

(57) ABSTRACT

A display device includes: a sensor, a display, and a processor. The processor is configured to set a primary user of the display, detect a hand of a user using the sensor, determine whether the detected hand is a hand of the primary user, based on the determination that the detected hand is the hand of the primary user, execute a first function according to a first movement of the detected hand, and control the display to display information corresponding to the first function.

### TECHNICAL FIELD

The present disclosure relates to an in-vehicle display device.

### BACKGROUND

A vehicle is an apparatus capable of moving a user in the user-desired direction. A representative example of a vehicle may be an automobile.

Meanwhile, for convenience of a user using a vehicle, various types of sensors and electronic devices are provided in the vehicle. In particular, for the convenience of the user's driving, Advanced Driver Assistance System (ADAS) has been actively researched. In addition, an autonomous vehicle is actively under development.

Meanwhile, as the development of the advanced driving assist system (ADAS) is actively undergoing in recent time, development of a technology for optimizing user's convenience and safety while driving a vehicle is required.

As part of this, displays are provided at various locations to display various V2X information, vehicle information, and the like. Further, more and more functions performed through a display are becoming available thanks to autonomous driving, various methods for controlling in-vehicle displays have been discussed.

### DISCLOSURE

### Technical Problem

One aspect of the present disclosure is directed to solving the aforementioned problems and other drawbacks. Another aspect of the present disclosure is to provide a display device capable of determining whether to execute a specific function according to whether a detected hand is a hand of a primary user of a display.

### Technical Solution

Embodiments disclosed herein provide a display device that may include a sensor; a display; and a processor configured to: detect a hand of a user using the sensor, and control the display to display information corresponding to a specific function executed based on a gesture made by the detected hand, wherein the processor is configured to: set a primary user of the display, and determine whether to execute the specific function according to whether the detected hand is a hand of the primary user.

In an embodiment, in case the detected hand is not the hand of the primary user, the processor may execute the specific function when a predetermined condition is satisfied.

More specifically, functions executable through the display may be classified into first and second groups, and in case the detected hand is not the hand of the primary user, the processor may execute the specific function when the specific function is classified as the first group.

In another embodiment, in case the detected hand is not the hand of the primary user, the processor may execute the specific function when a specific situation of the primary user is detected.

In another embodiment, in case the detected hand is not the hand of the primary user, the processor may control the display to output an object corresponding to the detected hand is outputted when the predetermined condition is satisfied.

Here, the processor may control the display such that a method of outputting the object is changed according to a gesture of the detected hand.

In another embodiment, when a first hand gesture made by a first user and a second hand gesture made by a second user are inputted within a predetermined time, the processor may execute a first function corresponding to the first hand gesture in preference to a second function corresponding to the second hand gesture. The first user may be the primary user, and the second user may be a user other than the primary user.

Here, the processor may not perform the second function when the first and second functions conflict with each other.

On the other hand, the processor may execute the second function after performing the first function when the first and second functions do not conflict with each other.

In another embodiment, the processor may control the display such that first and second objects that respectively correspond to a hand of the first user and a hand of the second user are output. The first and second objects may be different graphic objects.

In another embodiment, the processor may set a user sitting on a predetermined seat that corresponds to the display as a primary user.

Accordingly, the processor may determine whether the detected hand is a hand of the user sitting on the predetermined seat based on an image of seats in a vehicle captured using the sensor.

In another embodiment, the processor may acquire an image of a hand of the primary user captured using the sensor, and compare the acquired image with a captured image of the detected hand to determine whether the detected hand is the hand of the primary user.

To this end, when the predetermined seat is occupied by a passenger, the processor may control the display to display capturing guidance information for capturing a hand of the passenger on board is displayed thereon.

Embodiments disclosed herein also provide a display device that may include a sensor; a display; and a processor configured to: detect a hand of a user using the sensor and control the display to display information corresponding to a specific function executed based on to a gesture made by the detected hand, wherein the processor is configured to control the display such that an object corresponding to the detected hand is outputted, and wherein the object includes a gesture guidance area that corresponds to a space within a predetermined range with respect to a location of the detected hand.

In an embodiment, the processor may control the display such that information corresponding to a gesture made by the detected hand within the predetermined range of space is displayed thereon.

In an embodiment, the processor may control the display such that an icon moving according to the location of the detected hand is outputted to the gesture guidance area.

In another embodiment, the processor may control the display to be divided into first and second areas when first and second seats are occupied by passengers.

When a passenger sitting on the first seat gets off from a vehicle, the processor may control the display such that the first and second areas are combined into one area again.

In another embodiment, the display may be set to one of a plurality of preset modes according to a predetermined condition, and the processor may set a mode of the display to one of the plurality of modes based on user's state information sensed by the sensor.

### Advantageous Effects

A display device according to embodiments disclosed herein may provide at least one or more of the following benefits.

According to at least one of the embodiments of the present disclosure, a function that corresponds to a gesture applied to a relevant display may be executed according to whether a detected hand is a hand of a primary user. This may prevent the currently displayed content from being changed by a user who is not the primary user.

Also, a function that can be executed by a non-primary user may be executed in a limited manner, depending on whether the function conflicts with a function input by the primary user, a primary user's state, and the like.

In addition, as a gesture guidance area is outputted, a gesture can be applied in an easier manner.

Further, the display may be automatically divided or combined according to whether a passenger is on board. Accordingly, a limited area of the display can be used more efficiently, and thus power can be saved.

Furthermore, as a display mode is set according to the current state of a passenger, an output state of the display can be automatically changed without an unnecessary or additional input.

Further scope of applicability of the present disclosure will become apparent from the following detailed description. It should be understood, however, that the detailed description and specific examples, such as the preferred embodiment of the disclosure, are given by way of illustration only, since various changes and modifications within the spirit and scope of the disclosure will be apparent to those skilled in the art.

### BRIEF DESCRIPTION OF THE DRAWINGS

FIG. 1 is a view illustrating an outer appearance of a vehicle in accordance with an embodiment of the present disclosure.

FIG. 2 is a diagram illustrating an appearance of a vehicle at various angles in accordance with an implementation of the present disclosure.

FIGS. 3 and 4 are diagrams illustrating an inside of a vehicle in accordance with an implementation of the present disclosure.

FIGS. 5 and 6 are diagrams referenced to describe objects in accordance with an implementation of the present disclosure.

FIG. 7 is a block diagram referenced to describe a vehicle in accordance with an implementation of the present disclosure.

FIG. 8 is a block diagram illustrating a display device according to an embodiment of the present disclosure.

FIG. 9 is a conceptual view illustrating an example in which a specific function is executed according to whether a detected hand is a primary user's hand.

FIG. 10 is a conceptual view illustrating an example in which an object corresponding to a detected hand is outputted according to the case of FIG. 9.

FIG. 11 is a conceptual view illustrating an example in which a specific function is executed when gestures made by a plurality of hands are detected.

FIG. 12 is a conceptual view illustrating an example in which an object corresponding to a detected hand is outputted according to the case of FIG. 11.

FIG. 13 is a conceptual view illustrating an example in which capturing guidance information for capturing a hand image of a primary user is outputted.

FIG. 14 is a conceptual view illustrating an example in which a gesture guidance area is outputted.

FIG. 15 is a conceptual view illustrating an example in which an image output direction is changed by a gesture.

FIG. 16 is a conceptual view illustrating an example in which an image is transmitted by a gesture.

FIG. 17 is a conceptual view illustrating an example in which a menu is selected by a gesture.

FIG. 18A is a conceptual view illustrating an example in which a center console display is operated as a touchpad.

FIG. 18B is a conceptual view illustrating an example in which a screen is divided depending on whether a passenger is on board.

FIG. 19 is a conceptual view illustrating an embodiment in which a display area is divided by a gesture.

FIG. 20 is a conceptual view illustrating a specific example in which a center console display is operated as a touchpad.

FIG. 21 is a conceptual view illustrating an example in which a display is divided depending on whether a passenger is on board.

FIG. 22 is a conceptual view illustrating an example in which a display mode is switched according to a user's state.

### BEST MODE OF CARRYING OUT EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the main point of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present disclosure may be understood as a conception including cars, motorcycles and the like. Hereinafter, the vehicle will be described based on a car.

The vehicle according to the embodiment of the present invention may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

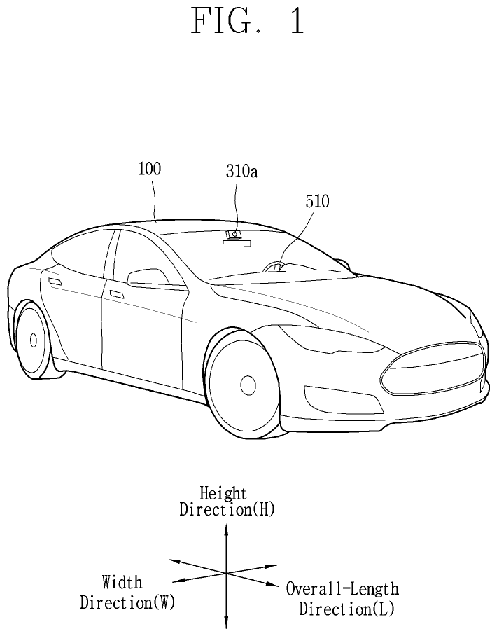

FIG. 1 is a diagram illustrating an outer appearance of a vehicle in accordance with an implementation of the present disclosure.

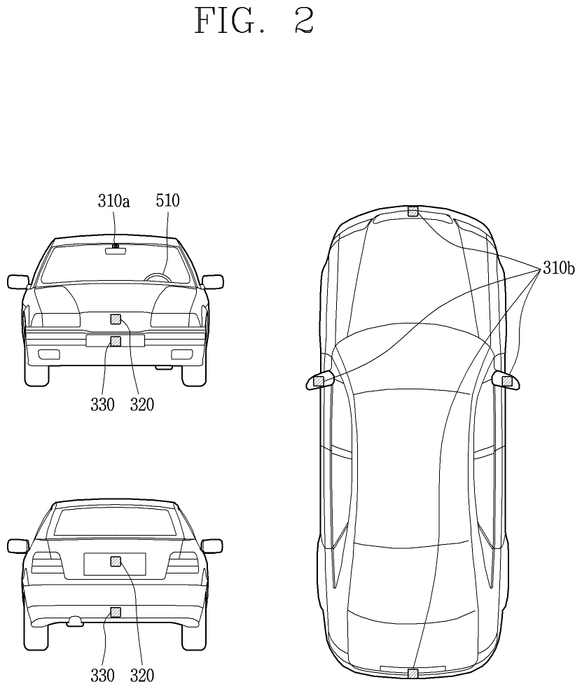

FIG. 2 is a diagram illustrating an appearance of a vehicle at various angles in accordance with an implementation of the present disclosure.

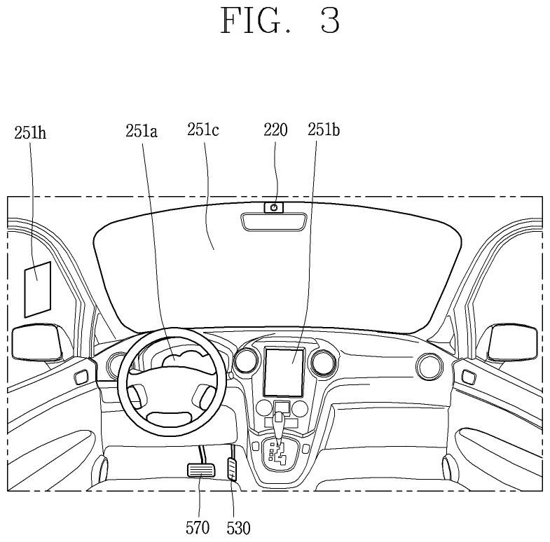

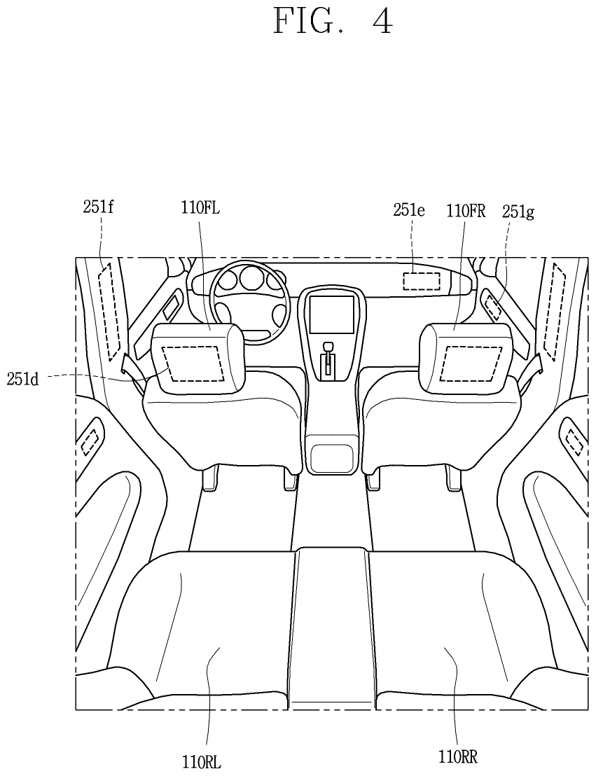

FIGS. 3 and 4 are diagrams illustrating an inside of a vehicle in accordance with an implementation of the present disclosure.

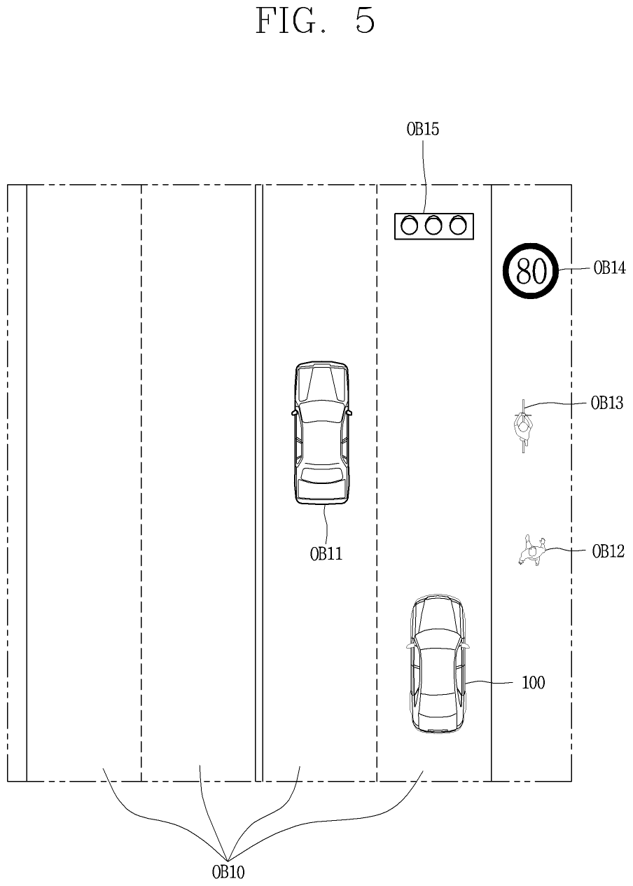

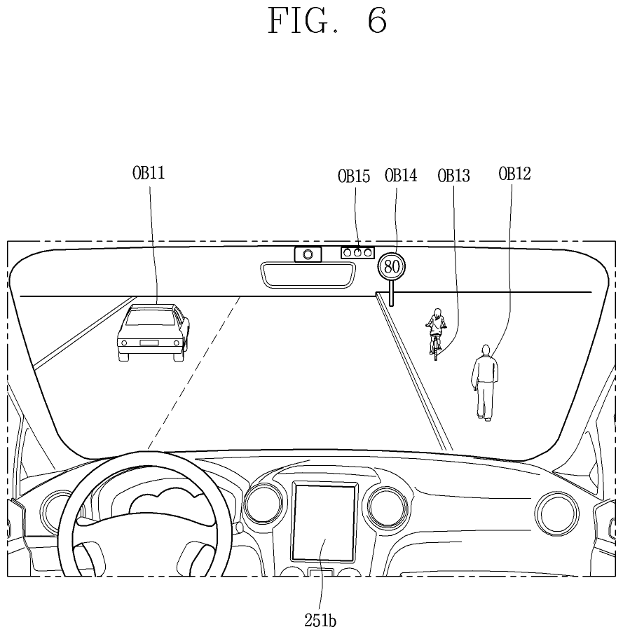

FIGS. 5 and 6 are diagrams referenced to describe objects in accordance with an implementation of the present disclosure.

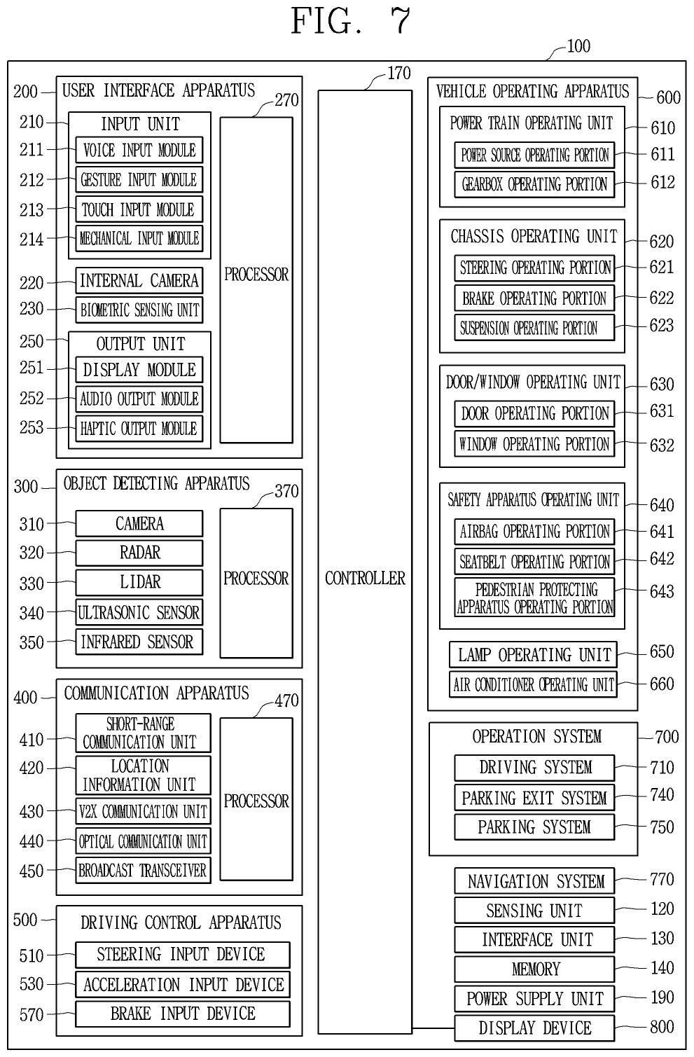

FIG. 7 is a block diagram referenced to describe a vehicle in accordance with an implementation of the present disclosure.

As illustrated in FIGS. 1 to 7, a vehicle 100 may include wheels turning by a driving force, and a steering input device 510 for adjusting a driving (proceeding, moving) direction of the vehicle 100.

The vehicle 100 may be an autonomous vehicle.

In some implementations, the vehicle 100 may be switched into an autonomous mode or a manual mode based on a user input.

For example, the vehicle 100 may be converted from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the vehicle 100 may be driven based on an operation system 700.

For example, the vehicle 100 may be driven based on information, data or signal generated in a driving system 710, a parking exit system 740 and a parking system 750.

When the vehicle 100 is driven in the manual mode, the vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 7, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, an interface unit 130, a memory 140, a controller 170 and a power supply unit 190.

According to some implementations, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 200 may implement user interfaces (UIs) or user experiences (UXs) through the user interface apparatus 200.

The user interface apparatus 200 may include an input unit 210, an internal camera 220, a biometric sensing unit 230, an output unit 250 and at least one processor, such as a processor 270.

According to embodiments, the user interface apparatus 200 may include more components in addition to components to be explained in this specification or may not include some of those components to be explained in this specification.

The input unit 210 may allow the user to input information. Data collected in the input unit 210 may be analyzed by the processor 270 and processed as a user's control command.

The input unit 210 may be disposed inside the vehicle. For example, the input unit 210 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 210 may include a voice input module 211, a gesture input module 212, a touch input module 213, and a mechanical input module 214.

The audio input module 211 may convert a user's voice input into an electric signal. The converted electric signal may be provided to the processor 270 or the controller 170.

The audio input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

According to some implementations, the gesture input module 212 may detect a user's three-dimensional (3D) gesture input. To this end, the gesture input module 212 may include a light emitting diode outputting a plurality of infrared rays or a plurality of image sensors.

The gesture input module 212 may detect the user's 3D gesture input by a time of flight (TOF) method, a structured light method or a disparity method.

The touch input module 213 may convert the user's touch input into an electric signal. The converted electric signal may be provided to the processor 270 or the controller 170.

The touch input module 213 may include a touch sensor for detecting the user's touch input.

According to an implementation, the touch input module 213 may be integrated with the display module 251 so as to implement a touch screen. The touch screen may provide an input interface and an output interface between the vehicle 100 and the user.

The mechanical input module 214 may include at least one of a button, a dome switch, a jog wheel and a jog switch. An electric signal generated by the mechanical input module 214 may be provided to the processor 270 or the controller 170.

The mechanical input module 214 may be arranged on a steering wheel, a center fascia, a center console, a cockpit module, a door and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing unit 230 may include a sensor for detecting the user's biometric information and acquire fingerprint information and heart rate information regarding the user using the sensor. The biometric information may be used for user authentication.

The output unit 250 may generate an output related to a visual, audible or tactile signal.

The output unit 250 may include at least one of a display module 251, an audio output module 252 and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent OLED, a transparent LCD, a transmissive transparent display and a transparent LED display. The transparent display may have adjustable transparency.

Meanwhile, the user interface apparatus 200 may include a plurality of display modules 251a to 251

The display module 251 may be disposed on one area of a steering wheel, one area 251a, 251b, 251e of an instrument panel, one area 251d of a seat, one area 251of each pillar, one area 251g of a door, one area of a center console, one area of a headlining or one area of a sun visor, or implemented on one area 251c of a windshield or one area 251h of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The processor 270 may control an overall operation of each unit of the user interface apparatus 200.

According to an embodiment, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

Meanwhile, the user interface apparatus 200 may be called as a display apparatus for vehicle.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

Referring to FIGS. 5 and 6, an object O may include a traffic lane OB10, another vehicle OB11, a pedestrian OB12, a two-wheeled vehicle OB13, traffic signals OB14 and OB15, light, a road, a structure, a speed hump, a terrain, an animal and the like.

The lane OB01 may be a driving lane, a lane next to the driving lane or a lane on which another vehicle comes in an opposite direction to the vehicle 100. The lanes OB10 may include left and right lines forming a lane.

The another vehicle OB11 may be a vehicle which is moving around the vehicle 100. The another vehicle OB11 may be a vehicle located within a predetermined distance from the vehicle 100. For example, the another vehicle OB11 may be a vehicle which moves before or after the vehicle 100.

The pedestrian OB12 may be a person located near the vehicle 100. The pedestrian OB12 may be a person located within a predetermined distance from the vehicle 100. For example, the pedestrian OB12 may be a person located on a sidewalk or roadway.

The two-wheeled vehicle OB13 may refer to a vehicle (transportation facility) that is located near the vehicle 100 and moves using two wheels. The two-wheeled vehicle OB13 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

Light may be light generated from a lamp provided in another vehicle, light generated from a street lamp, or solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge and the like.

The terrain may include a mountain, a hill and the like.

Meanwhile, objects may be classified into a moving object and a fixed object. For example, the moving object may include another vehicle or a pedestrian. The fixed object may be, for example, a traffic signal, a road, or a structure.

The object detecting apparatus 300 may include a camera 310, a radar 320, a LiDAR 330, an ultrasonic sensor 340, an infrared sensor 350 and at least one processor, such as processor 370.

According to an implementation, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an around view monitoring (AVM) camera 310b or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk or a tail gate.

For example, the camera 310 may be disposed adjacent to at least one of side windows within the vehicle to acquire a side image of the vehicle. Or, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a frequency shift Keyong (FSK) manner according to a signal waveform, among the continuous wave radar methods.

The radar 320 may detect an object in a time of flight (TOF) manner or a phase-shift manner through the medium of the electric wave, and detect a position of the detected object, a distance from the detected object and a relative speed with the detected object.

The radar 320 may be disposed on an appropriate position outside the vehicle for detecting an object which is located at a front, rear or side of the vehicle.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a TOP manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object and a relative speed with the detected object.

The ultrasonic sensor 340 may be disposed on an appropriate position outside the vehicle for detecting an object located at the front, rear or side of the vehicle.

The infrared sensor 350 may include infrared light transmitting and receiving portions. The infrared sensor 340 may detect an object based on infrared light, and detect a position of the detected object, a distance from the detected object and a relative speed with the detected object.

The infrared sensor 350 may be disposed on an appropriate position outside the vehicle for detecting an object located at the front, rear or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor may detect an object based on reflected infrared light which emitted infrared light is reflected from the object, and track the object. The processor 370 may execute operations, such as a calculation of a distance from the object, a calculation of a relative speed with the object and the like, based on the infrared light.

According to an embodiment, the object detecting apparatus 300 may include a plurality of processors 370 or may not include any processor 370. For example, each of the camera 310, the radar 320, the LiDAR 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 300 may operate according to the control of the controller 170.

The communication apparatus 400 is an apparatus for performing communication with an external device. Here, the external device may be another vehicle, a mobile terminal or a server.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

According to an embodiment, the communication apparatus 400 may further include other components in addition to the components described, or may not include some of the components described.

The short-range communication unit 410 is a unit for facilitating short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communication with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an embodiment, a light-emitting unit may be integrally formed with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

According to an embodiment, the communication apparatus 400 may include a plurality of processors 470 or may not include any processor 470.

When the processor 470 is not included in the communication apparatus 400, the communication apparatus 400 may operate according to the control of a processor of another device within the vehicle 100 or the controller 170.

Meanwhile, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (proceeding) direction of the vehicle 100 from the user. The steering input device 510 is preferably configured in the form of a wheel allowing a steering input in a rotating manner. According to some embodiments, the steering input device may also be configured in a shape of a touch screen, a touchpad or a button.

The acceleration input device 530 may receive an input for accelerating the vehicle 100 from the user. The brake input device 570 may receive an input for braking the vehicle 100 from the user. Each of the acceleration input device 530 and the brake input device 570 is preferably configured in the form of a pedal. According to some embodiments, the acceleration input device or the brake input device may also be configured in a shape of a touch screen, a touchpad or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some embodiments, the vehicle operating apparatus 600 may further include other components in addition to the components described, or may not include some of the components described.

Meanwhile, the vehicle operating apparatus 600 may include a processor. Each unit of the vehicle operating apparatus 600 may individually include a processor.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N) or parking (P).

Meanwhile, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

Meanwhile, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

Meanwhile, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may operate in an autonomous driving mode.

The operation system 700 may include a driving system 710, a parking exit system 740 and a parking system 750.

According to implementations, the operation system 700 may further include other components in addition to components to be described, or may not include some of the components to be described.

Meanwhile, the operation system 700 may include at least one processor. Each unit of the operation system 700 may individually include at least one processor.

According to implementations, the operation system 700 may be implemented by the controller 170 when it is implemented in a software configuration.

Meanwhile, according to implementations, the operation system 700 may be implemented by at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a processor. The memory may store the navigation information. The processor may control an operation of the navigation system 770.

According to embodiments, the navigation system 770 may update prestored information by receiving information from an external device through the communication apparatus 400.

According to embodiments, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (VVTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

Meanwhile, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be a variety of storage devices, such as ROM, RAM, EPROM, a flash drive, a hard drive and the like in a hardware configuration. The memory 140 may store various data for overall operations of the vehicle 100, such as programs for processing or controlling the controller 170.

According to implementations, the memory 140 may be integrated with the controller 170, or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

Meanwhile, the vehicle 100 according to the present disclosure may include a display device 800.

The display device 800 may control at least one of those components illustrated in FIG. 7. From this perspective, the display device 800 may be the controller 170.

Without a limit to this, the display device 800 may be a separate device, independent of the controller 170. When the display device 800 is implemented as a component independent of the controller 170, the display device 800 may be provided on a part of the vehicle 100.

Hereinafter, description will be given of implementations in which the display device 800 is a component which is separate from the controller 170, for the sake of explanation. As such, according to implementations described in this disclosure, the functions (operations) and control techniques described in relation to the display device 800 may be executed by the controller 170 of the vehicle. That is, every detail described in relation to the display device 800 may be applied to the controller 170 in the same/similar manner.

Also, the display device 800 described herein may include some of the components illustrated in FIG. 7 and various components included in the vehicle. For the sake of explanation, the components illustrated in FIG. 7 and the various components included in the vehicle will be described with separate names and reference numbers.

Hereinafter, a display device according to the present disclosure will be described in detail with reference to the accompanying drawings.

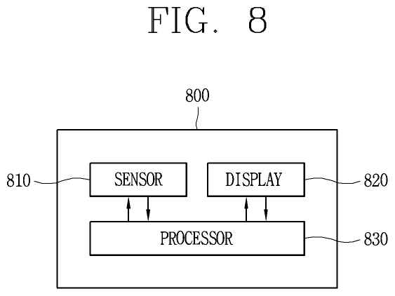

FIG. 8 is a block diagram illustrating a display device according to an embodiment of the present disclosure.

Referring to FIG. 8, the display device 800 according to the present disclosure includes a sensor 810, a display 820, and a processor 830.

The sensor 810 may include a camera, an infrared (IR) sensor, and the like.

In an embodiment, the camera may acquire an image inside the vehicle. Based on this image, a gesture, state, and gaze information of a user may be detected. The user's gesture may also be detected through the IR sensor.

The display 820 may output visual information and sense a touch input, a gesture input, and the like.

In an embodiment, the display 820 may activate a gesture detection sensor when a predetermined condition is satisfied. For example, when a passenger (or user) is in a situation difficult to apply a touch input, the gesture detection sensor may be activated.

More specifically, when it is determined that the user's hand is out of reach, based on an angle of a seat back, a position of a seat, and the like, when switched to the autonomous driving mode, when the user places his or her hand on another display, which is not the display corresponding to the seat, the gesture sensor may be activated.

In another embodiment, the display 820 may be disposed on one area of a steering wheel, one area 251a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

Alternatively, it may be implemented as a rear center console provided between rear (or back) seats 110RL and 110RR.

The processor 830 detects a hand of the user using the sensor 810 and controls the display 820 such that information corresponding a specific or predetermined function executed in response to a gesture of the detected hand is displayed thereon.

In an embodiment, the processor 830 sets a primary (or main) user of the display 820 and executes the specific function according to whether the detected hand is the primary user's hand.

In detail, one primary user may be set in one display 820. When the primary user applies a gesture input to the display 820, a function corresponding to the gesture input may be executed. On the other hand, when a user other than the primary user applies a gesture input to the display 820, a function corresponding to the gesture input may not be executed.

Hereinafter, the display device 800 according to the present disclosure will be described in detail with reference to the drawings.

Meanwhile, although the detected hand is not the primary user's hand, the processor 830 may execute the specific function when a predetermined condition is satisfied.

In an embodiment, functions executable through the display 820 are classified into first and second groups. In case the detected hand is not the primary user's hand, the processor 830 may perform the specific function when the specific function is classified as the first group.

In another embodiment, in case the detected hand is not the primary user's hand, the processor 830 may execute the specific function when a specific situation of the primary user is detected.

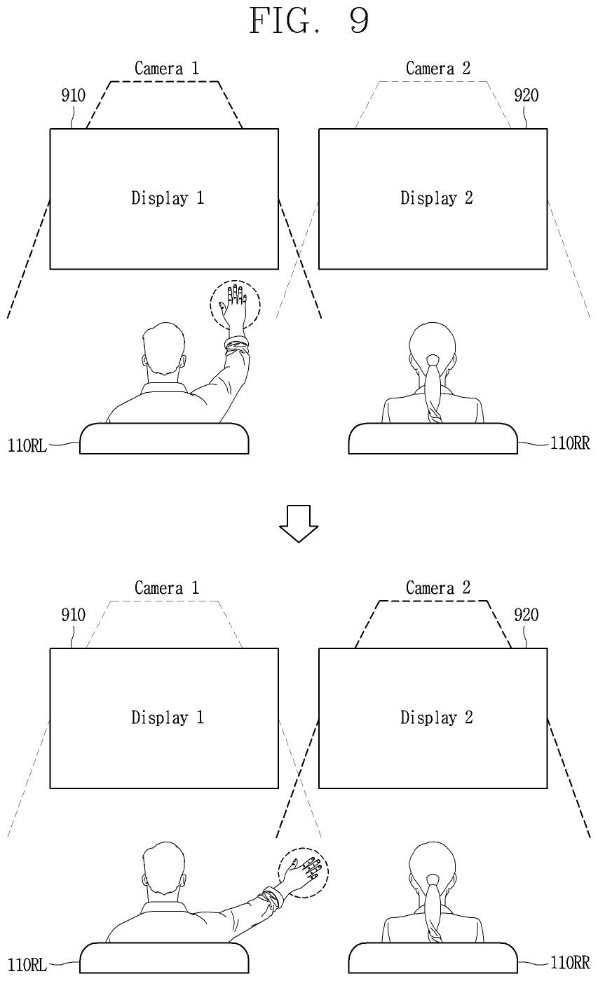

FIG. 9 is a conceptual view illustrating an example in which a specific function is executed according to whether a detected hand is a primary user's hand.

Referring to FIG. 9, a passenger who sits on a first seat 110RL may be set as a primary user of a first display (Display 1) 910, and a passenger who sits on a second seat 110RR may be set as a primary user of a second display (Display 2) 920.

In an embodiment, when a first user (who is the primary user of the first display 910) sitting on the first seat 110RL raises his (or her) hand toward the first display 910, a first camera may detect the hand of the first user.

In addition, information may be displayed on the first display 910 according to a detected hand gesture of the first user, namely, the primary user.

In another embodiment, when the first user moves his (or her) hand toward the second display 920, a second camera may detect the hand of the first user.

In this case, however, since the first user is not the primary user of the second display 920, limited functions may only be executed on the second display 920.

For example, among control commands (functions), a function of increasing or decreasing the aspect ratio of screen corresponding to the hand gesture of the first user may only be executed. Or, control commands, such as pause, rewind, and fast-forward, may be executed on the content being played, but a control command for changing the content itself may not be executed.

As another example, when a specific situation of a second user who is the primary user of the second display 920 is detected, information may be displayed on the second display 920 in response to a detected hand gesture of the first user.

In detail, when the second user is dozing off or getting out of the vehicle 100, or when it is difficult or impossible for the second user to apply a touch or gesture input, information may be displayed on the second display 920 according to the detected hand gesture of the first user, instead of the primary user of the second display 920.

That is, when the user is not the primary user of the corresponding display, a function executable by a hand gesture may be determined according to a type of function. Or, when it is difficult or unavailable for the primary user of the corresponding display to apply a touch or gesture input, or when the primary user gets off from the vehicle 100, information may be displayed on the corresponding display according to a hand gesture of a user who is not the primary user of the corresponding display.

In another embodiment, in case a primary user of the display is the driver, vehicle-related control functions may only be executed by a gesture input of the primary user.

For example, when a passenger other than the driver makes a gesture for manipulating navigation, a function corresponding to the navigation may not be executed by the gesture.

Meanwhile, even though a detected hand is not the primary user's hand, the processor 830 may control the display 820 to output an object corresponding to the detected hand when the predetermined condition is satisfied.

In an embodiment, the processor 830 may control the display 820 such that a method of outputting the object is changed according to a gesture made by the detected hand.

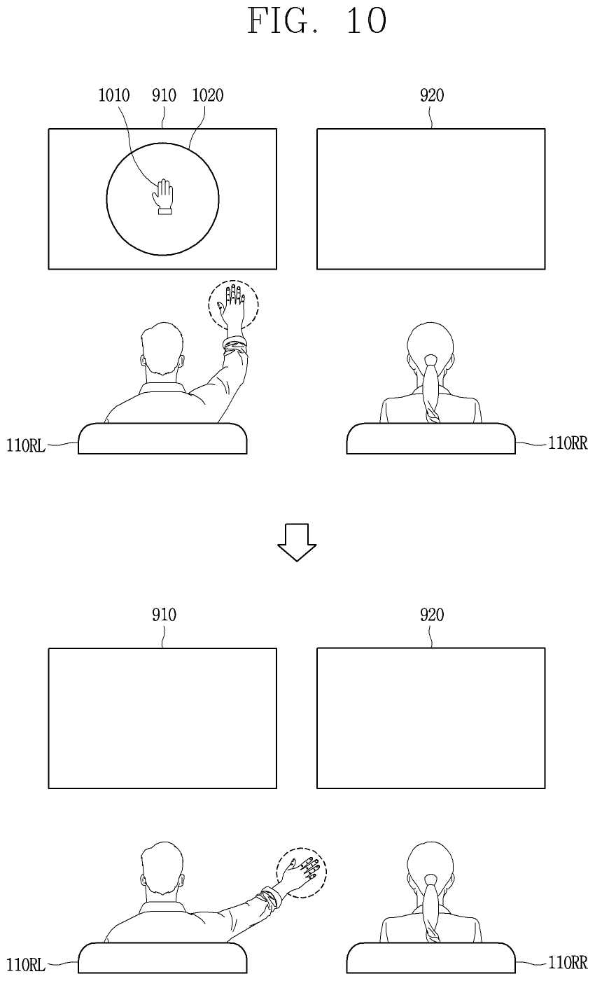

FIG. 10 is a conceptual view illustrating an example in which an object corresponding to a detected hand is outputted according to the case of FIG. 9.

Referring to FIG. 10, when the hand of the first user who is the primary user of the first display 910 is detected, objects 1010, 1020 corresponding to the hand of the first user may be outputted to the first display 910.

In an embodiment, a hand icon 1010 corresponding to a location (or position) of the hand of the first user and a gesture guidance area (or region) 1020 corresponding to a space within a predetermined range with respect to the location of the detected hand may be outputted.

Here, the hand icon 1010 may be outputted at the middle (or center) of the first display 910. Then, the gesture guidance area 1020 may be outputted as a circle having a predetermined radius around the hand icon 1010.

In another embodiment, the hand icon 1010 may move in response to movement of the hand of the first user within the gesture guidance area 1020.

In another embodiment, the first user may move his (or her) hand to the second display 920. Accordingly, the hand icon 1010 and the gesture guidance area 1020 disappear from the first display 910.

In addition, when a predetermined condition is satisfied, the objects 1010 and 1020 that correspond to the hand of the first user may be outputted to the second display 920.

In an embodiment, as described in FIG. 9, when a function is executed by a hand gesture of the first user, the objects 1010 and 1020 corresponding to the hand of the first user may be outputted to the second display 920.

In another embodiment, the objects 1010 and 1020 corresponding to the hand of the first user may be outputted to the second display 920 when it is difficult or unavailable for the second user to apply a touch or gesture input, or when the second user gets off from the vehicle 100.

In another embodiment, the objects 1010 and 1020 related to the hand of the first user may be displayed on the second display 920 only for a short period of time for which the hand of the first user moves (or passes) over to the second display 920.

Meanwhile, when a first hand gesture of the first user and a second hand gesture of the second user are input within a predetermined time, the processor 830 may execute a first function corresponding to the first hand gesture is executed in preference to a second function corresponding to the second hand gesture. The first user is the primary user, and the second user may be a user other than the primary user.

In an embodiment, when the first function and the second function conflict with one another, the processor 830 may not execute the second function.

In contrast, when the first function and the second function do not conflict with each other, the processor 830 may execute the second function after performing the first function.

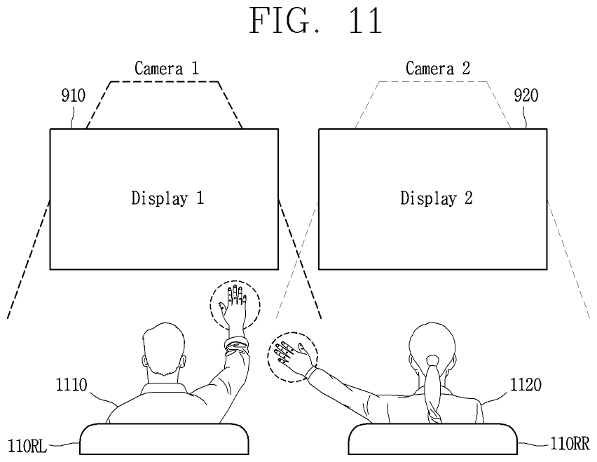

FIG. 11 is a conceptual view illustrating an example in which a specific function is executed when gestures made by a plurality of hands are detected.

Referring to FIG. 11, a first hand gesture made by a first user 1110 who is the primary user of the first display 910 and a second hand gesture made by a second user 1120 may be input within a predetermined time.

Here, a first function corresponding to the first hand gesture may be executed in preference to a second function corresponding to the second hand gesture. That is, a higher priority is given to a control command of the primary user.

In an embodiment, when the first function corresponding to the first hand gesture and the second function corresponding to the second hand gesture conflict with each other, the second function may not be executed. For instance, when the first hand gesture is a gesture for playing video content, and the second hand gesture is a gesture for ending the playback of the video content, the video content may be played by the first hand gesture.

In another embodiment, when the first function corresponding to the first hand gesture and the second function corresponding to the second hand gesture do not conflict with each other, the second function may be executed after the first function is performed.

More specifically, when the first hand gesture is a gesture for playing first video content, and the second hand gesture is a gesture for playing second video content, the second video content may be played after the first video content is played. Alternatively, the second video content may be played together with the first video content.

Meanwhile, the processor 830 controls the display 820 such that first and second objects that respectively correspond to the first user's hand and the second user's hand. The first and second objects may be different graphic objects.

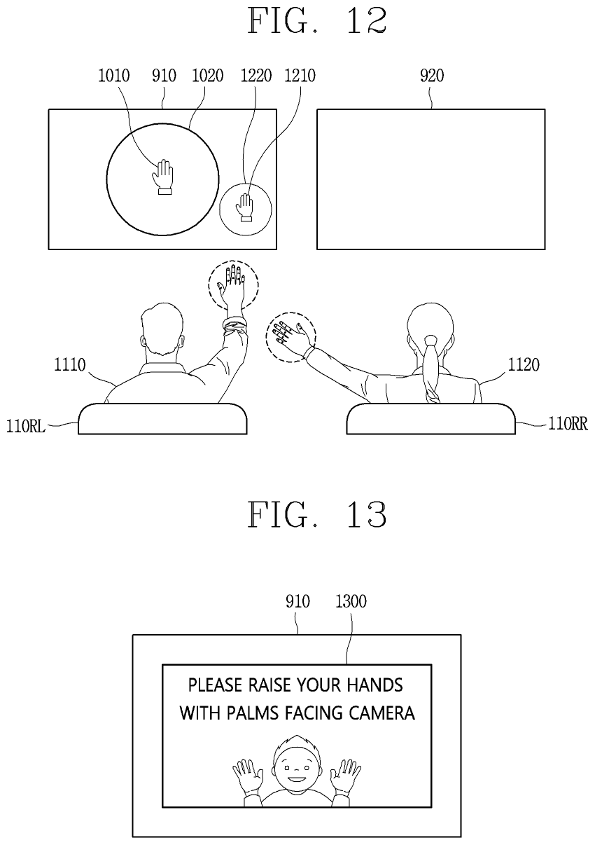

FIG. 12 is a conceptual view illustrating an example in which an object corresponding to a detected hand is outputted according to the case of FIG. 11.

Referring to FIG. 12, when the hand of the first user 1110 who is the primary user of the first display 910 is detected, the objects 1010 and 1020 corresponding to the hand of the first user may be displayed on the first display 910.

In an embodiment, the hand icon 1010 corresponding to a location of the hand of the first user 1110 and the gesture guidance area 1020 corresponding to a space within a predetermined range with respect to the location of the detected hand may be outputted.

Here, the hand icon 1010 may be outputted in the middle of the first display 910. In addition, the gesture guidance area 1020 may be outputted as a circle having a predetermined radius around the hand icon 1010.

In a subsequent embodiment, the second user 1120 may move her (or his) hand to the first display 910. Then, objects (1210, 1220) corresponding to the hand of the second user 1120 may be outputted to the first display 910.

Likewise, a hand icon 1210 corresponding to a hand location of the second user 1120 and a gesture guidance area 1220 corresponding to a space within a predetermined range with respect to the location of the detected hand may be outputted.

In another embodiment, the objects 1010 and 1020 corresponding to the hand of the first user 1110 and the objects 1210 and 1220 corresponding to the hand of the second user 1120 may be outputted differently, such as having different shapes, sizes, and colors, transparency, and the like.

In detail, the gesture guidance area 1220 in association with the second user 1120 may be outputted to an edge area of the first display 910 in a size smaller than the gesture guidance area 1020 related to the first user 1110.

Alternatively, the gesture guidance area 1220 related to the second user 1120 may be outputted in a color different from a color of the gesture guidance area 1020 related to the first user 1110, or output in a blurry manner having different transparency.

In another embodiment, as described above, when a function performed by a hand gesture of the first user 1110 and a function performed by a hand gesture of the second user 1120 conflict with one another, the objects 1210 and 1220 corresponding to the hand of the second user 1120 may not be outputted from the first display 910 any longer.

Meanwhile, the processor 830 may set a user sitting on a predetermined seat corresponding to the display 820 as a primary user.

In an embodiment, the processor 830 may determine whether a detected hand is a hand of the user sitting on the predetermined seat based on an image of seats in the vehicle 100 captured using the sensor 810.

More specifically, the processor 830 may determine whether the detected hand is the hand of the user sitting on the rear left seat or rear right seat from the captured image of the rear seats in the vehicle 100.

In another embodiment, the processor 830 may acquire an image of the primary user's hand captured using the sensor 810, and compare the acquired image with a captured image of the detected hand to determine whether the detected hand is the hand of the primary user.

To this end, when a passenger sits on the predetermined seat, the processor 830 may control the display 820 such that capturing guide information for capturing a hand image of the passenger is displayed.

In another embodiment, a captured hand image of the primary user may be stored when a vehicle is purchased or when a display 910 is initially set.

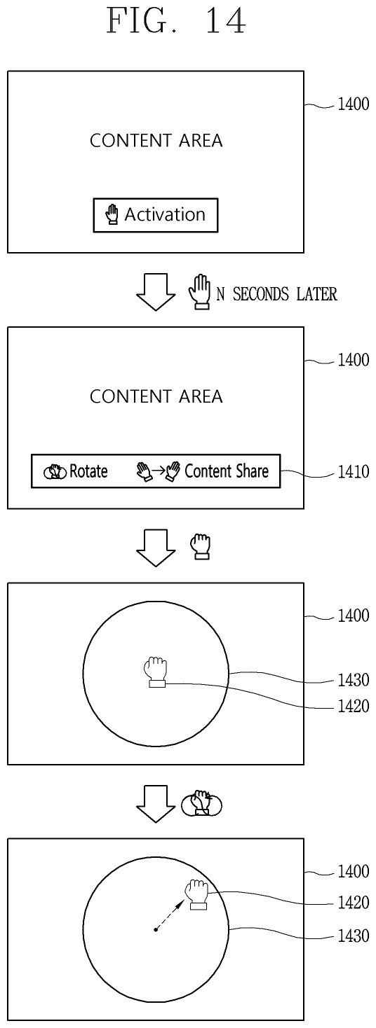

FIG. 13 is a conceptual view illustrating an example in which capturing guidance information for capturing a hand image of a primary user is outputted.

Referring to FIG. 13, a primary user of the first display 910 may be set as a passenger who sits on a first seat.

Accordingly, when a first user sits on the first seat, (capturing) guidance information 1300 for capturing an image of both hands of the first user may be outputted to the first display 910.

In an embodiment, according to the guidance information 1300, the first user may proceed with capturing images of hands with palms facing the camera and with the back of the hands facing the camera.

Thereafter, it is determined whether a detected hand is the hand of the primary user by comparing the image of the both hands captured according to the guidance information 1300 with a captured image of the detected hand.

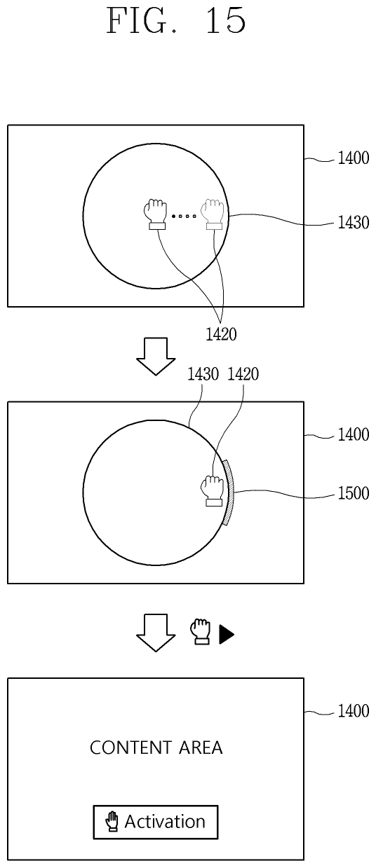

Hereinafter, embodiments in which a display is controlled by a gesture will be described in detail with reference to FIGS. 14 to 22.

Meanwhile, the processor 830 controls the display 820 such that an object corresponding to the detected hand is outputted. The object may include a gesture guidance area corresponding to a space within a predetermined range based on a location of the detected hand.

In an embodiment, the processor 830 may control the display 820 to display information corresponding to a gesture of the detected hand performed within the predetermined range of space.

In another embodiment, the processor 830 may control the display 820 such that an icon moving according to the location of the detected hand is outputted to the gesture guidance area.

FIG. 14 is a conceptual view illustrating an example in which a gesture guidance area is outputted.

Referring to FIG. 14, when a user raises his or her hand with a palm facing a display 1400, the hand of the user may be recognized. In an embodiment, during the process of hand recognition, a predetermined visual effect such as lighting may be outputted to the display 1400.

When the hand recognition is completed after a specific time has elapsed, a sound feedback indicating this may be outputted, and gesture control (gesture control mode) may be started. In addition, gesture guidance information 1410 (gesture guidance area) for controlling the output screen may be outputted to one area of the display 1400.

In an embodiment, when the user clenches his or her fist of the raised hand toward the display 1400, a fist icon 1420 may be outputted in the middle area of the display 1400.

In addition, a gesture guidance area 1430 having a circular shape with a predetermined radius with respect to the fist icon 1420 may be outputted. Here, the gesture guidance area 1430 may be an area corresponding to a space within a predetermined range based on a location of the detected hand (a location of the hand during the process of recognition, a position detected by the camera).

Then, when the user moves the hand while clenching his or her fist within the predetermined range of space, the fist icon 1420 moves in response to movement of the hand within the gesture guidance area 1430.

Further, screen information being outputted to the display 1400 may also be changed. For example, an output angle of a 360-degree rotating image may be changed according to movement of the clenched hand.

As another example, when an output angle of a 360-degree rotating video is changed as the clenched hand moves, the video may be paused. When the clenched hand stops moving, the video may be played again.

In another embodiment, if there is no gesture input for a predetermined time after the gesture guidance information 1410 is outputted, the gesture control mode may be ended.

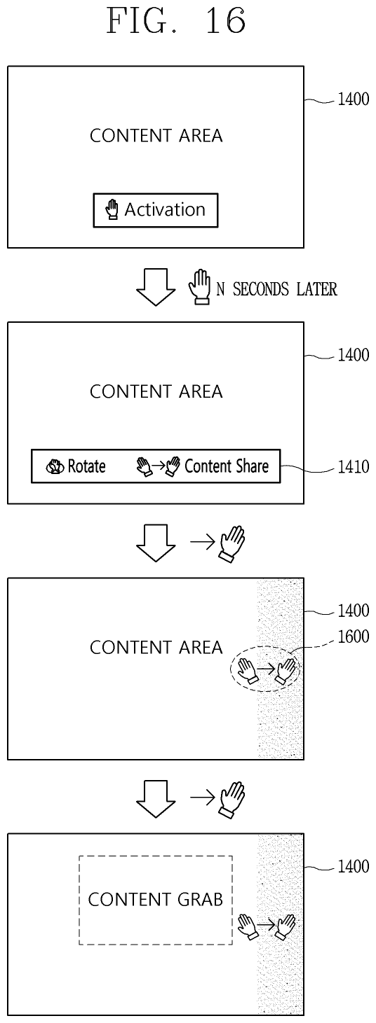

FIG. 15 is a conceptual view illustrating an example in which an image output direction is changed by a gesture.

Referring to FIG. 15, which is a subsequent embodiment of FIG. 14, when the clenched hand is stationary after moving to the right within the predetermined range of space, the fist icon 1420 moves to the right and comes to a stop near a right boundary line of the gesture guidance area 1430.

In this case, the output angle of the 360-degree rotating image may be continuously moved (rotated) to the right.

As another example, as the fist icon 1420 moves closer to the boundary line, namely, as the clenched hand moves to the right within the predetermined range of space, a rotation speed of the 360-degree rotating image may increase.

In another embodiment, when the clenched hand continues to move to the right and is out of the predetermined range of space, a notification (warning) indicating this may be outputted.

More specifically, a specific (or predetermined) visual effect 1500 such as flashing may be outputted to a portion of the gesture guidance area 1430 where the fist icon 1420 is about to pass over. Alternatively, a bar-shaped object that surrounds the portion of the gesture guidance area 1430 may be outputted in a color and shape different from other portions.

If the fist icon 1420 passes over the gesture guidance area 1430, namely, when the clenched hand is out of the predetermined range of space as it continues to move to the right, the gesture control (gesture control mode) may be ended.

In another embodiment, when the clenched hand moves inward again (i.e., the hand moving to the right moves to the left), screen movement may be stopped.

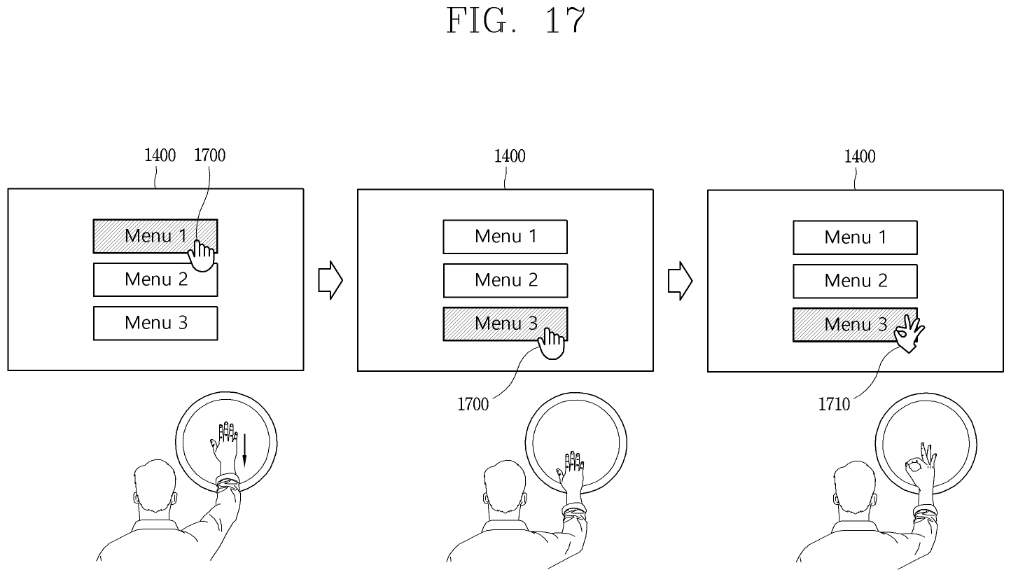

FIG. 16 is a conceptual view illustrating an example in which an image is transmitted by a gesture.

Referring to FIG. 16, as described in FIG. 14, when a user raises his or her hand with a palm facing the display 1400, the hand of the user may be recognized. In an embodiment, during the process of hand recognition, a predetermined visual effect such as lighting may be outputted to the display 1400.

When the hand recognition is completed after a specific time has elapsed, a sound feedback indicating this may be outputted, and gesture control (gesture control mode) may be started. In addition, the gesture guidance information 1410 for controlling the output screen may be outputted to one area of the display 1400.

More specifically, when the user moves the hand with the palm facing the display 1400 to the right, an icon 1600 corresponding to a gesture for screen sharing may be displayed on a right side of the display 1400.

Accordingly, when the user moves his or her hand to a space (a recognizable range of content sharing gesture) corresponding to an area on the right side of the display 1400 and shakes the hand to the right, the content being output may be grabbed. In addition, the content may be outputted to another display.

For example, as the corresponding content is transmitted, a video being output to the screen of left Rear Seat Entertainment (RSE) may also be outputted to the screen of right RSE.

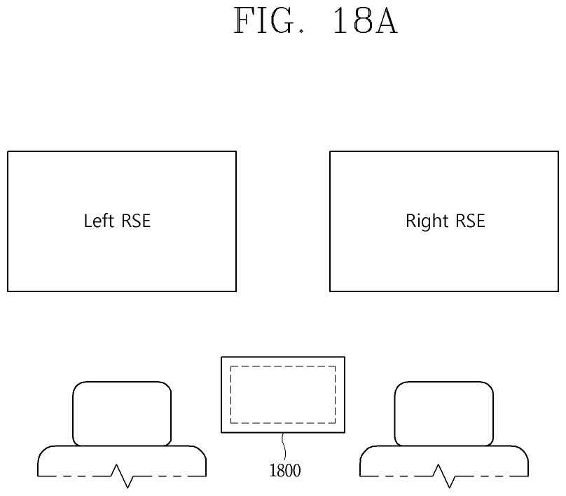

FIG. 17 is a conceptual view illustrating an example in which a menu is selected by a gesture.

Referring to FIG. 17, as described above, when selectable menu items are displayed on the display 1400 while the gesture mode is activated, a hand icon 1700 may be displayed on a first menu.

In an embodiment, when a user lowers his (or her) hand within a virtual range, which is a gesture recognizable range, the hand icon 1700 may be moved to a third menu displayed below the first menu.

Then, when the user makes a specific gesture with the detected hand, the third menu may be selected. Here, a changed icon 1710 may be outputted in response to the specific gesture.

In another embodiment, when the user makes a specific gesture in the virtual range of boundary area, a menu or list page may be changed.

Meanwhile, when the first and second seats are occupied, the processor 830 may control the display 820 to be divided into first and second areas.

In an embodiment, the processor 830 may control the display 820 such that the first and second areas are combined into one area again when a passenger sitting on the first seat gets off from the vehicle.

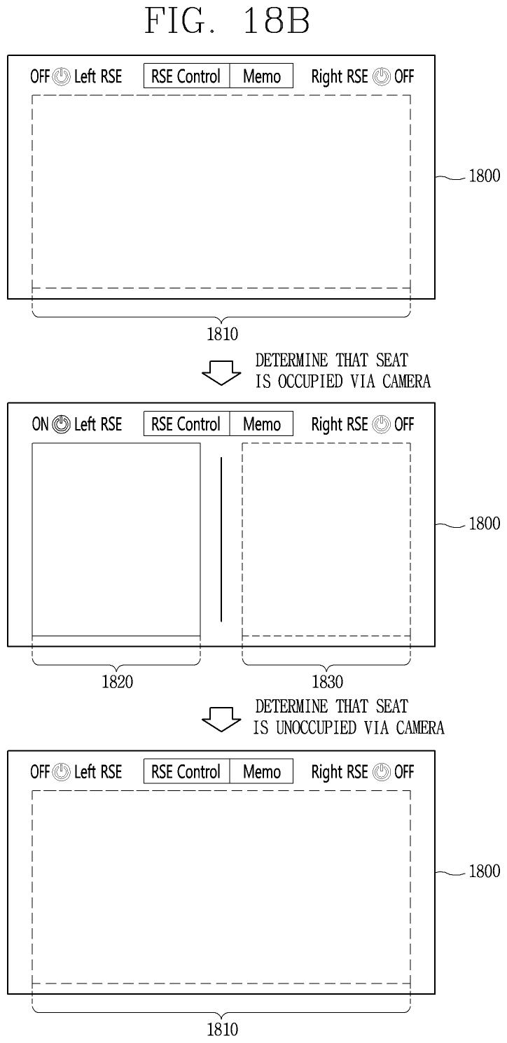

FIG. 18A is a conceptual view illustrating an example in which a center console display is operated as a touchpad.

Referring to FIG. 18A, a display 1800 of a center console in the rear seats may operate as a touchpad of the left RSE and right RSE.

In an embodiment, content output to the RSE may be changed by a touch or gesture input applied to the display 1800 of the center console. Alternatively, a mouse pointer, or the like may be outputted to the display 1800 of the center console.

In another embodiment, the power of the display 1800 of the center console may be OFF until before a rear seat is occupied. Thereafter, when at least one of the rear seats is occupied by a passenger, the power of the display 1800 of the center console may be turned ON.

In another embodiment, when at least one of the rear seats is occupied by a passenger, the display 1800 of the center console 1800 may be divided into two areas. In addition, the power of the display 1800 of the center console 1800 adjacent to a side where the passenger sits on may be turned ON.

Hereinafter, specific examples related to the center console display 1800 will be described.

FIG. 18B is a conceptual view illustrating an example in which a screen is divided depending on whether a passenger is on board.

Referring to FIG. 18B, the display 1800 of the center console 1800 of the rear seats may have one whole area 1810 before a passenger is on board. At this time, the power of the whole area 1810 may be OFF.

In an embodiment, when a passenger sits on the rear left seat, the whole area 1810 may be divided into a first area 1820 adjacent to the rear left seat 110RL and a second area 1830 adjacent to the rear right seat 110RR.

Here, a camera capturing the inside of the vehicle 100 may detect whether the rear left seat is occupied. Also, the power of the first area 1820 may be turned ON again.

Subsequently, when the rear left seat is unoccupied, the divided areas may be combined into the one whole area 1810 again. At this time, the camera capturing the inside of the vehicle 100 may detect whether the seat is occupied or unoccupied, and the power of the whole area 1810 may be set to ON.

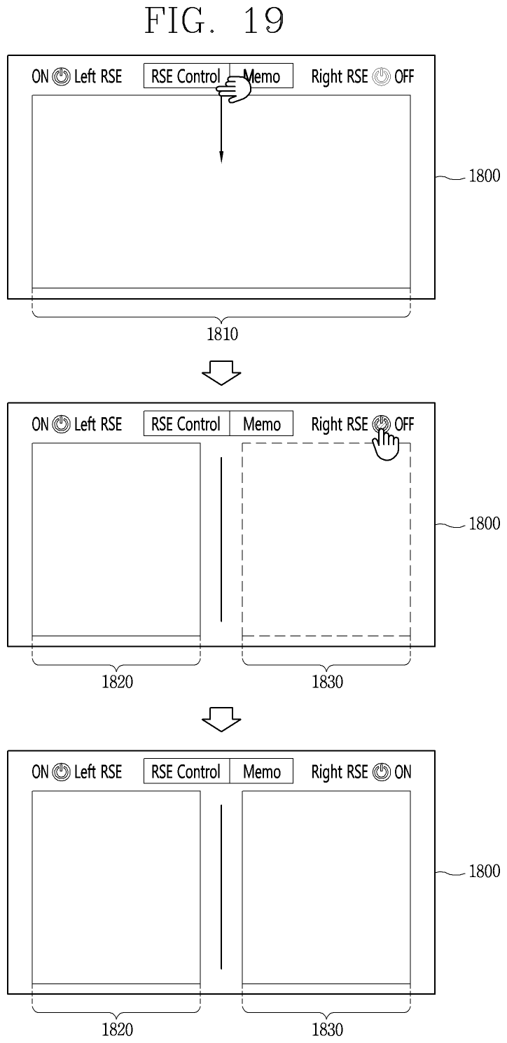

FIG. 19 is a conceptual view illustrating an embodiment in which a display area is divided by a gesture.

Referring to FIG. 19, as described above, the display 820 may be implemented as the center console located between the two rear seats 110RL and 110RR. Here, the display 820 may include the one whole area 1810.

In an embodiment, when a downward swipe is applied to the one whole area 1810, which is one touch (gesture)-available area, the area may be divided into the two areas 1820 and 1830. At this time, a predetermined animation effect may be outputted.

For example, it may be divided into the first area 1820 adjacent to the rear left seat 110RL and the second area 1830 adjacent to the rear right seat 110RR.

Alternatively, the display 820 may include power buttons corresponding to the left RSE and right RSE. When the power is ON, a gesture (touch) applied to the respective areas may be sensed. In addition, when the power is ON, a lighting effect may be outputted to the power button.

In an embodiment, when a downward swipe is applied while the power of the left area is ON, the one whole area 1810 may be divided into the two areas 1820 and 1830. At this time, the power of the first area 1820 may be ON, and the power of the second area 1830 may be OFF.

Subsequently, when a touch is applied to the power button of the second area 1830, the power of the second area 1830 may be turned ON.

In another embodiment, when an upward swipe is applied while being divided into the two areas 1820 and 1830, the divided areas 1820 and 1830 may be combined into the one whole area 1810 again.

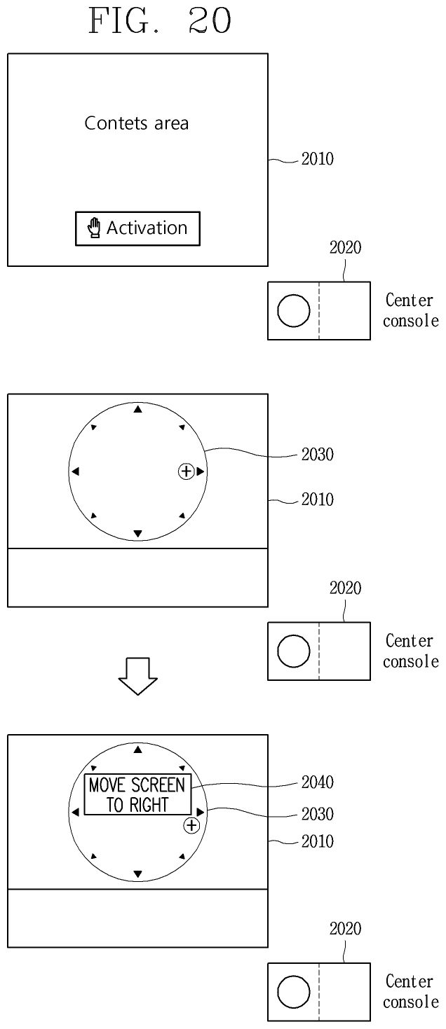

FIG. 20 is a conceptual view illustrating a specific example in which a center console display operates as a touchpad.

Referring to FIG. 20, when a touch (tap) is applied to a display 2020 of the center console in the rear seats, a cursor guide 2030 indicating a screen moving direction may be outputted to an RSE display 2010.

In an embodiment, an area corresponding to the cursor guide 2030 may be set in the display 2020 of the center console. For example, when a user applies a touch input to the display 2020 of the center console, a circular area having a predetermined radius may be set with respect to a point to which the touch input is applied. Here, the area corresponding to the cursor guide 2030 may be displayed on the display 2020 of the center console.

In addition, a touch input (click) may be applied to an area of the display 2020 of the center console corresponding to the cursor guide 2030, so as to change an image output direction.

For example, when an input for selecting a right cursor of the cursor guide 2030 is applied to the area of the display 2020 of the center console, the screen may be moved to the right and a message 2040 indicating this may be outputted.

In another embodiment, when there is no input to the area of the display 2020 of the center console for a predetermined time, the output of the cursor guide 2030 may be terminated.

Meanwhile, the display 820 may be set to one of a plurality of preset modes according to a predetermined condition, and the processor 830 may detect a user's state (or status) using the sensor 810 based on information regarding the user's state, and the mode of the display 820 may be set as one of the plurality of modes.

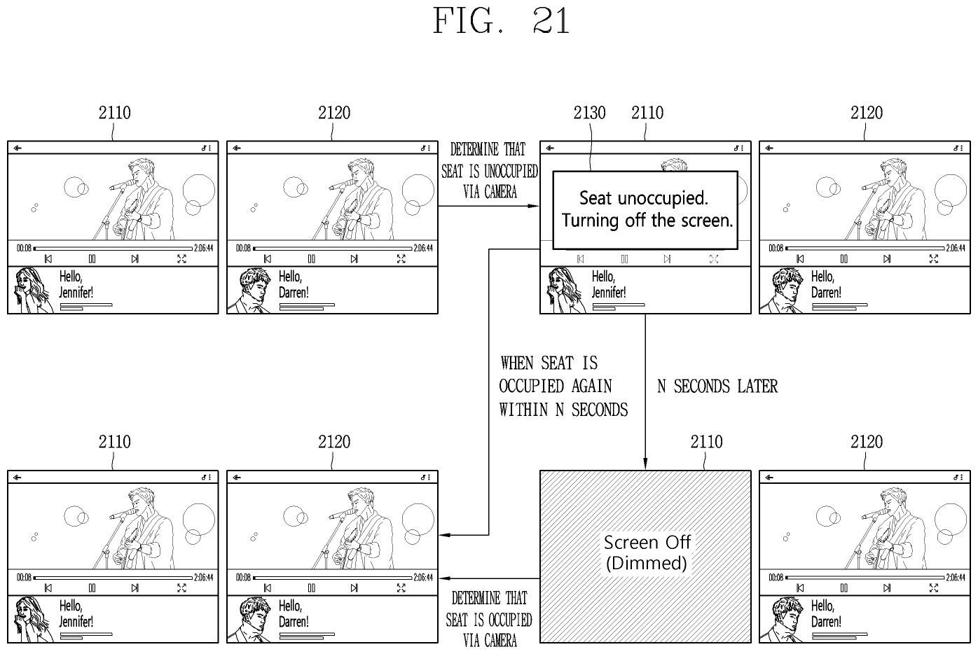

FIG. 21 is a conceptual view illustrating an example in which a display is divided depending on whether a passenger is on board.

Referring to FIG. 21, while content is being output to a first display 2110 that corresponds to a first seat and a second display 2120 that corresponds to a second seat, a passenger sitting on the first seat may get off from the vehicle 100. The camera capturing the inside of the vehicle 100 may detect whether the seat is occupied or unoccupied.

Accordingly, a message 2130 indicating that the screen is switching to the OFF state as the first seat is unoccupied may be outputted to the first display 2110, and the first display 2110 may be turned OFF after a predetermined time has elapsed.

In an embodiment, when the first seat is occupied again, the power of the first display 2110 may be turned ON.

In another embodiment, when the first seat is occupied again within the predetermined time, the power of the first display 2110 may not be turned OFF, and may be returned to the original state.

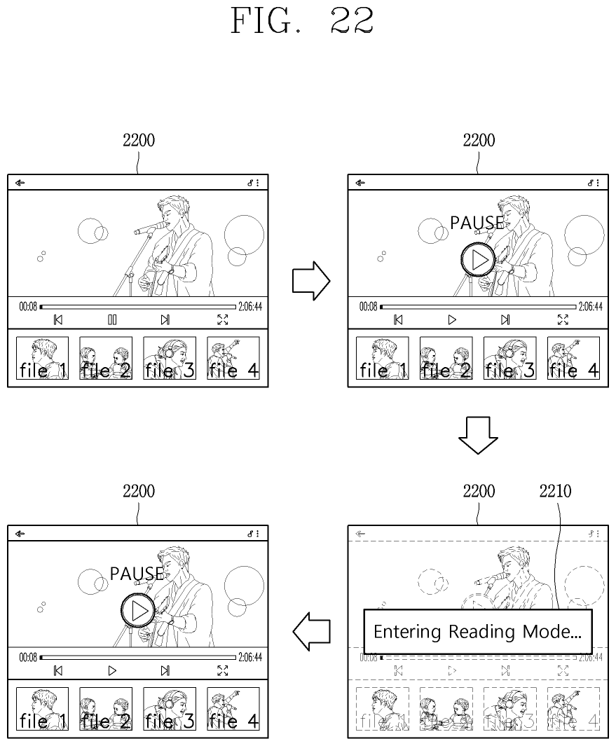

FIG. 22 is a conceptual view illustrating an example in which a display mode is switched according to a user's state.

Referring to FIG. 22, when a passenger takes a specific action while a video is being played on a display 2200, for example, when the passenger does not stare at the display 2200 (reading a book or newspaper is detected by the camera), the video may be paused.

As a subsequent embodiment, a message 2210 indicating that a specific mode (Reading Mode) has been set may be outputted after a predetermined time has elapsed. In the specific mode, the video being displayed on the screen is blurred, and the message 2210 may only be outputted.

Thereafter, when the passenger watches the video again (putting down the book or newspaper is detected by the camera), the video may be played again.

In another embodiment, when the passenger takes a specific action while content is being displayed on the display 2200, for example, when the passenger does not stare at the display 2200 (reading a book or newspaper is detected by the camera), this may be detected.

Accordingly, after a predetermined time has elapsed, the message 2210 indicating that the specific mode (Reading Mode) has been set may be outputted. In the specific mode, the content being displayed on the screen is blurred, and the message 2210 may only be outputted.

Thereafter, when the passenger stares at the screen again (putting down the book or newspaper is detected by the camera), the content may be outputted again.

In a related embodiment, some functions of the display may be limited in the specific mode, which may be set when the passenger does not gaze at the screen. In detail, the content being output is blurred, and a message indicating the specific mode may only be outputted. Alternatively, a notification message (message reception) may be outputted as a pop-up together with a sound effect, a haptic effect, or the like.

A display device according to the embodiments disclosed herein may provide at least one or more of the following benefits.

According to at least one of the embodiments of the present disclosure, a function that corresponds to a gesture applied to a relevant display may be executed according to whether a detected hand is a hand of a primary user. This may prevent the currently displayed content from being changed by a user who is not the primary user.

Also, a function that can be executed by a non-primary user may be executed in a limited manner, depending on whether the function conflicts with a function input by the primary user, a primary user's state, and the like.

In addition, as a gesture guidance area is outputted, a gesture can be applied in an easier manner.

Further, the display may be automatically divided or combined according to whether a passenger is on board. Accordingly, a limited area of the display can be used more efficiently, and thus power can be saved.

Furthermore, as a display mode is set according to the current state of a passenger, an output state of the display can be automatically changed without an unnecessary or additional input.

The present disclosure can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the processor or the controller. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

1. A display device, comprising:
a sensor;
a display; and
a processor,.
wherein the processor is configured to:
set a primary user of the display,
detect a hand of a user using the sensor,
determine whether the detected hand is a hand of the primary user,
based on the determination that the detected hand is the hand of the primary user, execute a first function according to a first movement of the detected hand, and control the display to display information corresponding to the first function.

2. The display device of claim 1, wherein the processor is configured to
based on (i) the determination that the detected hand is not the hand of the primary user and (ii) a predetermined condition being satisfied, execute the first function.

3. The display device of claim 2, wherein functions executable through the display are classified into a first group and a second group, and
wherein the processor is configured to, based on (i) the determination that the detected hand is not the hand of the primary user and (ii) the classification that the first function is classified into the first group, execute the first function.

4. The display device of claim 2, wherein the processor is configured to, based on (i) the determination that the detected hand is not the hand of the primary user and (ii) a specific situation associated with the primary user being detected, execute the first function.

5. The display device of claim 2, wherein the processor is configured to control the display to output an object corresponding to the detected hand based on (i) the determination that the detected hand is not the hand of the primary user and (ii) the predetermined condition being satisfied.

6. The display device of claim 5, wherein the processor is configured to control the display to change a method of outputting the object based on a second movement of the detected hand.

7. The display device of claim 1, wherein the processor is configured to:
execute the first function over a second function based on the first movement of a first user and a second hand movement of a second user being inputted within a predetermined time,
wherein the first function is associated with the first movement and the second function is associated with the second hand movement, and
wherein the first user is the primary user, and the second user is a user other than the primary user.

8. The display device of claim 7, wherein the processor is configured to not execute the second function based on the first function and the second function being conflicted with each other.

9. The display device of claim 8, wherein the processor is configured to execute the second function after the execution of the first function based on the first function and the second function being not conflicted with each other.

10. The display device of claim 9, wherein the processor is configured to control the display to output a first object and a second object corresponding to a hand of the first user and a hand of the second user,
wherein the first object and the second object are different graphic objects.

11. The display device of claim 1, wherein the processor is configured set a user sitting on a predetermined seat corresponding to the display as a primary user.

12. The display device of claim 11, wherein the processor is configured to determine whether the detected hand is a hand of the user sitting on the predetermined seat based on an image of seats in a vehicle including the display device, the image captured using the sensor.

13. The display device of claim 11, wherein the processor is configured to:
acquire an image of a hand of the primary user captured using the sensor, and
compare the acquired image with a captured image of the detected hand to determine whether the detected hand is the hand of the primary user.

14. The display device of claim 13, wherein the processor is configured to control, based on a passenger occupying the predetermined seat, the display to display capturing guidance information for capturing a hand of the passenger.

15. A display device, comprising:
a sensor;
a display; and
a processor,.
wherein the processor configured to:
detect a hand of a user using the sensor,
execute a function based on a movement of the detected hand,
control the display to display information corresponding to the function, and
control the display to output an object corresponding to the detected hand,
wherein the object includes a gesture guidance area corresponding to a space within a predetermined area with respect to a location of the detected hand.

16. The display device of claim 15, wherein the processor is configured to control the display to display information corresponding to a movement of the detected hand within the space.

17. The display device of claim 16, wherein the processor is configured to control the display to output a moving icon in response to the movement of the detected hand.

18. The display device of claim 15, wherein the processor is configured to control the display to be divided into a first area and a second area based on a first seat and a second seat being occupied by passengers.

19. The display device of claim 18, wherein the processor is configured to control the display to combine the first area and the second area based on one of the first seat and the second seat being unoccupied.

20. The display device of claim 15, wherein the display is set to one of a plurality of preset modes based on a predetermined condition, and
wherein the processor is configured to set a mode of the display to one of the plurality of modes based on user's state information sensed by the sensor.
